(19) United States
(12) Patent Application Publication
(10) Pub. No.: US 2019/0352944 A1
(43) Pub. Date: Nov. 21, 2019

(54) HANDLE COMPRISING A MOVABLE LOCK CYLINDER UNIT

(71) Applicant: Huf Hülsbeck & Fürst GmbH & Co. KG, Velbert (DE)

(72) Inventors: Willi Put, Winterswijk Meddo (NL); Marion Kilian, Velbert (DE); Oleg Dornhof, Neuss (DE)

(73) Assignee: Huf Hülsbeck & Fürst GmbH & Co. KG, Velbert (DE)

(21) Appl. No.: 16/484,132

(22) PCT Filed: Dec. 19, 2017
(86) PCT No.: PCT/EP2017/083558

§ 371 Date: Aug. 7, 2019

(30) Foreign Application Priority Data
Feb. 24, 2017 (DE) 10 2017 103 959.7

(51) Int. Cl. E05B 79/06; E05B 85/06; E05B 85/16

(52) U.S. Cl. CPC E05B 79/06; E05B 85/16; E05B 85/06

(57) ABSTRACT

A handle for a motor vehicle includes a mounting carrier which can be secured on the inside of a door of the motor vehicle, and a grip level that can be arranged on the outside of the door of the motor vehicle and is secured to said mounting carrier. A lock cylinder unit is mounted such that it can move on the mounting carrier, as a result of which the lock cylinder unit can be displaced between a pre-mounting position and a final mounting position.

### CROSS REFERENCE TO RELATED APPLICATIONS

This application claims priority under 35 U.S.C. § 371 to Patent Cooperation Treaty Application No. PCT/EP2017/083558, filed Dec. 19, 2017, which claims priority to DE Application No. 102017103959.7, filed Feb. 24, 2017, the contents of which are incorporated herein by reference in their entireties.

### FIELD

The present invention relates to a handle for a vehicle. Furthermore, the invention relates to a method for mounting a handle for a motor vehicle.

### BACKGROUND

This section provides background information related to the present disclosure and is not necessarily prior art.

It is known from the prior art to mount handles of a motor vehicle with a mounting carrier which is fastened on the inside of a motor vehicle door, and a grip lever, which is arranged on the outside of the door. It has been shown disadvantageously that there are always mounting delays and mounting inaccuracies. Among other things, it is because some components of the handle are difficult to mount due to their geometry, especially as the space conditions often complicate this.

It is therefore an object of the present invention to at least partially overcome the disadvantages described above. In particular, it is the object of the present invention to create a handle that can be fastened on the motor vehicle as installation-friendly as possible.

### SUMMARY

This section provides a general summary of the disclosure, and is not a comprehensive disclosure of its full scope or all its features.

One aspect of the disclosure provides a handle and another aspect provides a method. Further features and details of the invention will become apparent from the claims, the description and the drawings. Thereby, features and details that are described in connection with the handle according to the invention, of course also apply in connection with the method according to the invention, and respectively vice versa, so that, with respect to the disclosure of individual aspects of the invention, alternate reference is always or can be made.

The object is achieved in particular by a handle for a motor vehicle, with a mounting carrier which can be fastened on the inside of a door of the motor vehicle, a grip lever, which can be arranged on the outside of the door of the motor vehicle and can be fastened to the mounting carrier. Here, it is provided in particular that a closing cylinder unit is movably mounted on the mounting carrier, whereby the closing cylinder unit can be brought between a pre-mounting position and a final mounting position. When the closing cylinder unit is in the pre-mounting position, enough space is provided for the grip lever to fasten it directly or indirectly to the mounting carrier. In the final mounting position, the closing cylinder unit is accessible to the user, in particular via a key. Advantageously, a compact structural unit of the handle can be created via the movable closing cylinder unit. The pre-mounting position avoids any collisions with the grip lever to be fastened to the mounting carrier. Advantageously, the mounting carrier represents a common component with the movable closing cylinder unit, which is initially arranged on the inside of the door by the operator, wherein the closing cylinder unit is in the pre-mounting position.

A further advantage can be achieved within the context of the invention if the closing cylinder unit is rotatably mounted about an axle. It has been shown advantageous that a rotatable closing cylinder unit favors the compactness of the handle according to the invention. In addition, the closing cylinder unit appears to be less susceptible to wear and/or the kinematics can constructively be reduced to a few components.

Further, it may be provided within the context of the invention that the mounting carrier has a control element which is movable from a retaining position into a securing position, wherein, in the retaining position of the control element, the closing cylinder unit is in the pre-mounting position and in the securing position of the control element, the closing cylinder unit is in the final mounting position. The control element is movably arranged on the mounting carrier and can be moved between the retaining position and the securing position, wherein the control element advantageously acts on the closing cylinder unit, whereby it can be brought into its respective pre-mounting or final mounting position. Advantageously, the control element is movably mounted in the mounting carrier, wherein the operator can act on the control element in order to effect a corresponding movement of the closing cylinder unit.

Furthermore, it is possible within the context of the invention, that the closing cylinder unit has a control geometry, which is engaged by the control element, in particular that the control element has a connecting element which is in operative connection with the control geometry. The connecting element may be formed, for example, as a cam or projection or recess. The connecting element travels during the movement of the control element along the control geometry, whereby the movement of the closing cylinder unit from the pre-mounting position into the final mounting position and/or vice versa is effected. The connecting element thus exerts a force on the control geometry which makes the closing cylinder unit move.

Advantageously, it can be provided in the invention that the control geometry is at least partially curved. The control geometry can likewise have partially linear sections, whereby the movement, in particular rotational movement, of the closing cylinder unit can be substantially influenced.

In addition, it is conceivable within the context of the invention that the control element has an actuator, wherein, upon actuation of the actuator, a movement of the control element is effected from the retaining position into the securing position and/or vice versa. The actuator can be in an exposed position, so that the operator can easily actuate it. In this embodiment, the actuator is the drive means to move the control element or the closing cylinder unit, accordingly.

It may be provided that the actuator is located at least partially outside the mounting carrier. Advantageously, a fastening of the mounting carrier on the inside of the door takes place initially, wherein the easily visible actuator is accessible to the user in an installation-friendly manner. Advantageously, the actuator may have a corresponding identifier or color, thereby increasing the ease of mounting.

It can be provided within the context of the invention that the actuator is manually operated. It may be that the actuator can be operated via a corresponding tool. Furthermore, it is conceivable that the actuator is a screw element which acts on the mounting carrier and on the control element.

It is conceivable that the mounting carrier is designed with a cavity in which the control element is inserted, wherein the cavity is designed so that the control element is movable within the cavity between the retaining position and the securing position. For example, the cavity can determine the motion limits of the control element. In addition, the invention can provide that the cavity is at least partially adapted to the geometry of the control element, whereby a reliable guide of the control element within the cavity is ensured between the retaining position and the securing position. Advantageously, the control element is merely inserted into the cavity. Falling out of the cavity can be prevented, for example, by the actuator connecting the control element to the mounting carrier.

It can further be possible that the control element has a reception in which the closing cylinder unit is arranged, in particular that the closing cylinder unit is partially enclosed by the control element. On the one hand, the control element provides protection for the closing cylinder unit. On the other hand, a good storage of the closing cylinder unit on the control element can be effected hereby.

A further advantage within the context of the invention can be achieved if the control element has two securing sides and one actuation side, wherein the actuation side connects both opposing securing sides and the closing cylinder unit is arranged between both securing sides. Advantageously, the closing cylinder unit can be enclosed by at least three sides of the control element, wherein the actuator is advantageously arranged on the actuating side in order to move the control element accordingly. Advantageously, the control element is designed in a U-shaped manner. The rotation axis of the closing cylinder unit can at least pass through one of the two securing sides. A compact handle can be achieved if the securing sides are formed longer in their extension than the actuation side.

As a further advantage it may be provided that the control element has a rib on at least one of its sides, whereby a reliable guide is effected during the movement of the control element on the mounting carrier, in particular that at least one securing side has the rib. The rib may be in contact with a wall of the cavity, whereby the path of movement of the control element is fixed. The rib also facilitates that, during the movement of the control element, the latter cannot twist or tilt. The rib preferably extends along the entire extension of the control element, in particular the securing side. Advantageously, the control element forms a unitary, common and/or monolithic component with the rib. It may further be possible that a rib is respectively provided on several sides of the control element. The direction of the extension of the rib corresponds to the movement direction of the control element, which is advantageous with regards to the guide within the cavity.

Furthermore, it is conceivable that the control element is arranged within the mounting carrier in such a manner that the control element is linearly movable between the retaining position and the securing position. The linear movement of the control element favors an uncomplicated design of the movement kinematics for the closing cylinder unit.

It is also conceivable that the control element has a reception region and the closing cylinder unit has an axle body, through which the axle passes, wherein the axle body is arranged in the reception region, wherein, in particular upon movement of the control element, the axle body moves relatively within the reception region. The reception region of the control serves as a bearing to ensure a reliable movement of the closing cylinder unit. Advantageously, during the movement of the control element, only a rotational movement of the closing cylinder unit takes place about its axle. This means that the closing cylinder unit does not experience any linear movement. As the control element moves, the reception region is correspondingly designed extended to provide reliable mounting for the axle body.

It is additionally advantageous if the reception region has an inner region and an edge region, wherein the reception region is designed as an opening, which becomes smaller from the inner region to the edge region, wherein, in the retaining position of the control element, the axle body is located in the inner region, and in the securing position of the control element, the axle body is located in the edge region. The reception region designed open on one side has the advantage that the closing cylinder unit with its axle body can easily be mounted into the reception region. The edge region and the inner region offer a corresponding movement space for the axle body, whereby the kinematics for the movement of the control element and the closing cylinder unit is ensured. Advantageously, the inner region can form a stop for the axle body.

A further advantage can be achieved within the context of the invention if the axle body is designed like a cylinder, wherein the lateral surface of the axle body at least partially has at least one level surface which contacts the wall of the reception region in the securing position of the control element. Advantageously, the cylindrical design of the axle body favors a reliable rotational movement of the closing cylinder unit about its axle. The level surface can, in the securing position of the control element or in the final mounting position of the closing cylinder unit, rest on a level wall of the reception region, in particular the edge region of the reception region, whereby a latching of the closing cylinder unit is achieved in the final mounting position. As, preferably, the level surfaces of the axle body and the reception region of the control element lie on top of each other, the final mounting position of the closing cylinder unit is reliably retained.

In a further possibility it can be provided that the closing cylinder unit has at least one latching element which engages a counter latching element of the control element in the securing position of the control element, wherein, in the retaining position of the control element, the latching element is detached from the counter latching element, wherein in particular the latching element and/or the counter-latching element is/are formed rib-like. Advantageously, an additional position securing of the closing cylinder unit in the final mounting position can be effected hereby. The control thus not only has the function of moving the closing cylinder unit, but also reliably securing the closing cylinder unit in the final mounting position, wherein the securing is created on the one hand by the counter-latching element just described but also by the special geometric design of the reception region, in that the axle body is movably mounted.

Furthermore, it can be provided within the context of the invention that a movable activation element is arranged on the mounting carrier, wherein in the holding position, the control element engages the activation element, whereby the activation element is held in a mounting position in order to enable a simplified mounting of the grip lever, in the securing position the control element is detached from the activation element. Advantageously, the activation element is rotatably mounted about an axle on the mounting carrier. A closing and/or opening action for the motor vehicle door can be triggered by a movement of the activation element. For example, it is conceivable that the activation element triggers an opening process of a lock arranged on the door via its movement. The trigger of a corresponding action by the activation element can be done mechanically and/or electrically or wireless. As the grip lever is in operative connection with the activation element, the user can trigger a corresponding action for opening and/or closing the motor vehicle door by actuating the handle.

The object of the invention is also a method for mounting a handle for a motor vehicle, in particular a handle according to the invention, which has just been described, with a mounting carrier which can be fastened on the inside of a door of the motor vehicle, a grip lever, which can be arranged on the outside of the door of the motor vehicle and is fastened to the mounting carrier, a closing cylinder unit that is movably mounted on the mounting carrier. Here it is provided that, via a movement of a control element, which is arranged on the mounting carrier and is in operative connection with the closing cylinder unit, the closing cylinder unit moves from a pre-mounting position into a final mounting position. The method according to the invention thereby brings about the same advantages as described in detail with reference to the handle according to the invention. In addition, the method may be suitable for reliably fastening the handle to the activation element, wherein the control element holds the activation element in its mounting position at the same time. After mounting, the control element is in the securing position, wherein the handle is positioned directly on the door and the activation element assumes its operating position deviating from the mounting position.

It may further be possible that in the pre-mounting of the closing cylinder unit, the grip lever is arranged on the mounting carrier, in particular on an activation carrier movable on the mounting carrier, and subsequently the control element is moved from the retaining position into the securing position. Advantageously, the pre-mounting position for the grip lever provides sufficient mounting clearance for a reliable fastening to the activation element.

Preferably, it can be provided that in the retaining position, the control element holds the activation element in a mounting position, wherein during the movement of the control element into the securing position, the control element detaches from the activation element, which moves into an operating position. The control element has several functions, on the one hand, it effects a transfer of the closing cylinder unit from the pre-mounting position into the final mounting position and/or vice versa. On the other hand, the control element holds the activation element in its mounting position in order to provide a simple mounting of the handle on the activation element. The operative connection between the control element and the activation element detaches when the control element is moved into the securing position.

Further advantages, features and details of the invention will become apparent from the following description in which exemplary embodiments of the invention are described in detail with reference to the drawings. Thereby, the features mentioned in the claims and in the description can be essential for the invention respectively individually or in an arbitrary combination.

### DRAWINGS

The figures show:

FIG. 1 illustrates a schematic view of a handle for a motor vehicle according to the invention;

FIG. 2 illustrates a view of a mounting carrier with a control element, which is in a securing position;

FIG. 3 illustrates a further view of the mounting carrier, wherein the control element is in a retaining position, which differs from the securing position;

FIG. 4 illustrates a further view of the control element according to FIG. 3;

FIG. 5 illustrates a further perspective view of the control element according to FIG. 3;

FIG. 6 illustrates a further view of the control element according to FIG. 3;

FIG. 7 illustrates a further view of the control element, wherein the control element is in its securing position;

FIG. 8 illustrates a further view of the control element, at which a securing element is arranged, wherein the control element is in the retaining position;

FIG. 9 illustrates a further view of the control element, which takes up the securing position;

FIG. 10 illustrates a further view of the control element, at which the securing element is arranged, wherein the control element is in the retaining position;

FIG. 11 illustrates the control element in its securing position;

FIG. 12 illustrates the control element, which is engaged in the closing cylinder unit.

In the following figures, the same reference numerals are used for the same technical features also of different exemplary embodiments.

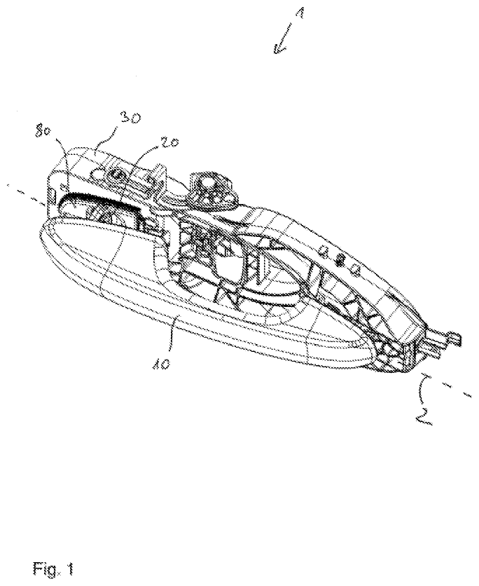

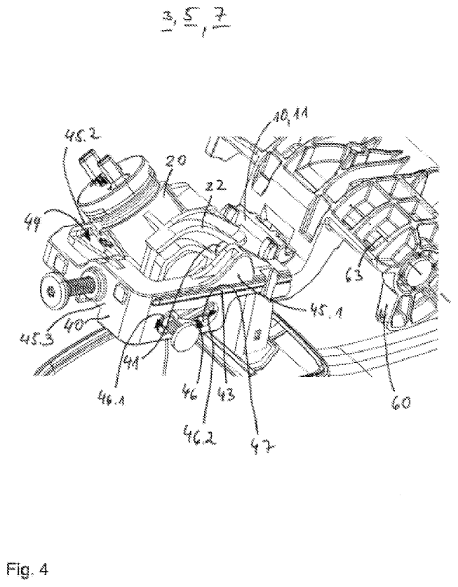

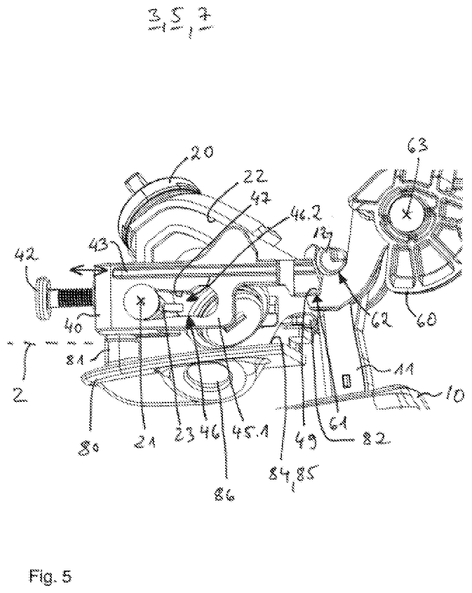

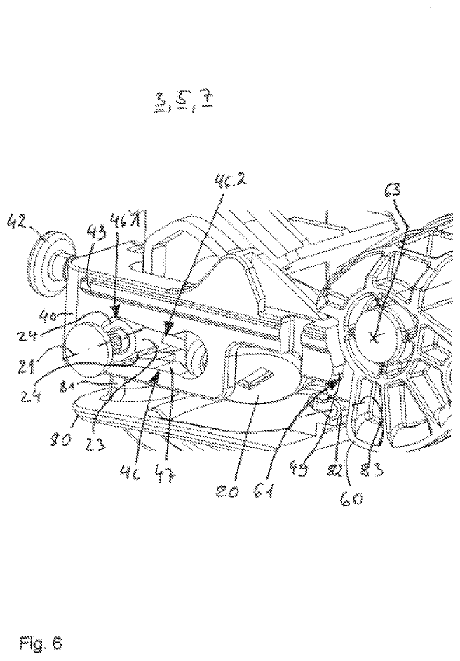

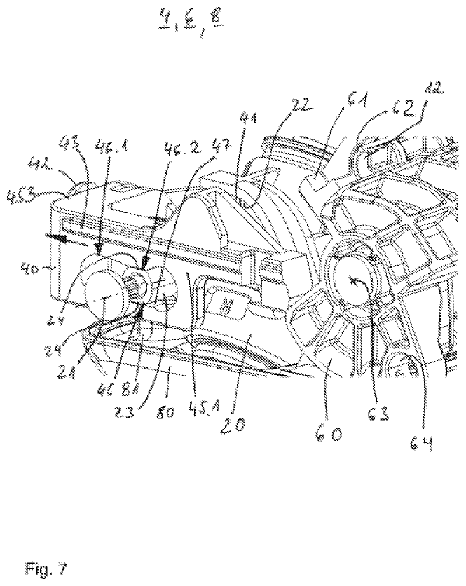

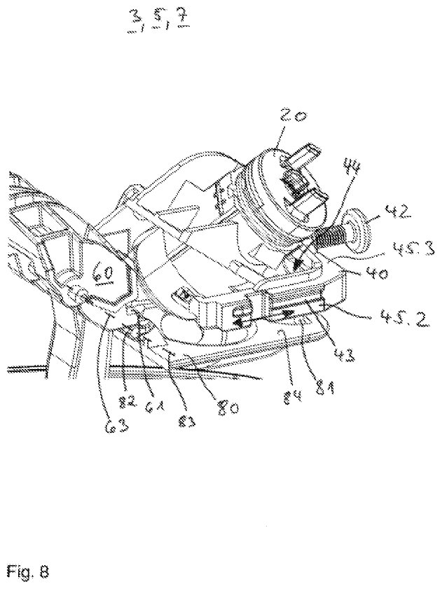

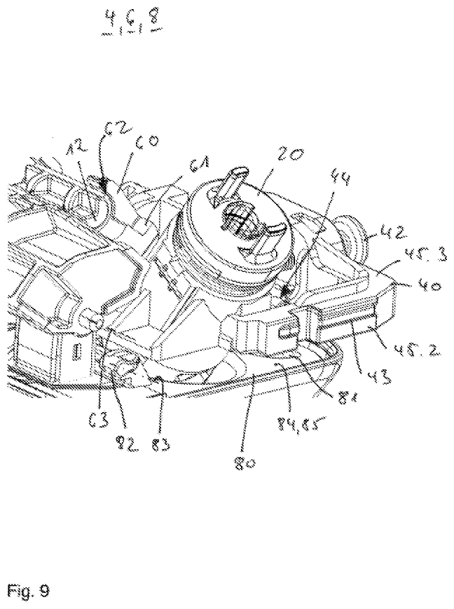

FIGS. 1 to 12 shows an exemplary embodiment of a handle 1 according to the invention, which can be fastened to a door 2 of a motor vehicle. The handle 1 has a mounting carrier 30, which is fastened on the inside of the door 2. On the outside of the door 2, the handle 1 has a grip lever 10, which is to be actuated by the operator, in particular can be pulled, wherein according to FIG. 1 the grip lever 10 is a pulling grip lever. The grip lever 10 is rotatably mounted on the mounting carrier on its right side, which is not shown explicitly. On its left side, the grip lever 10 has a dome 11, which is shown for example in FIG. 5, so that by a pulling action of the user, the dome 11 initiates an action of a defined kinematics within the mounting carrier 30. According to the exemplary embodiment, the grip lever 10 is in operative connection with an activation element 60, which means that a release for a closing system within the motor vehicle can be triggered by a movement of the activation element 60. For example, it is conceivable that an opening process and/or closing process of a door 2, etc. can be effected via a movement of the activation element 60. In the present exemplary embodiment, the activation element 60 is rotatably mounted on the mounting carrier 30 about an axis 63. The activation element 60 has a fastening zone 62, in which a free end 12 of the mandrel 11 is held reliably. The activation element 60 additionally has a fastening reception 64, which is shown for example in FIG. 7, in which, for example, a Bowden cable can be fastened. By means of a corresponding movement of the activation element 60, the Bowden cable can be pulled, whereby a mechanical release action is started.

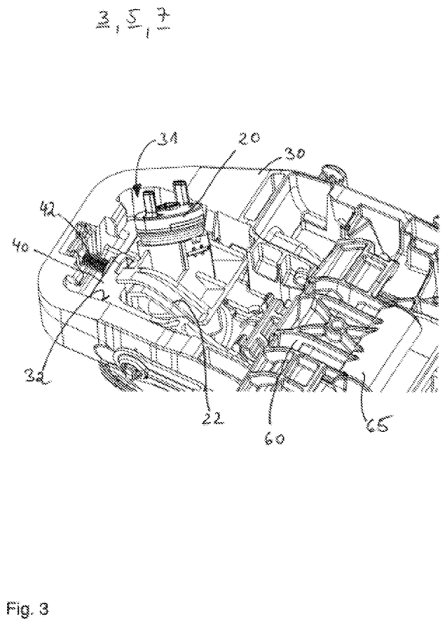

In addition, it is conceivable that the activation element 60 has a mass balance 65, which is shown in FIG. 3. The mass balance 65 serves to prevent the door handle 10 from moving out of the door 2 via the acceleration forces in the event of a crash.

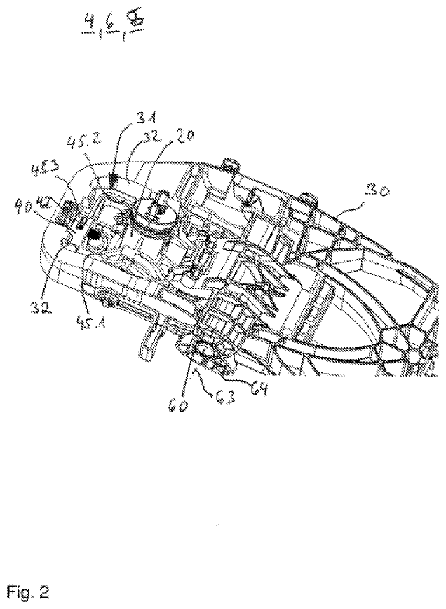

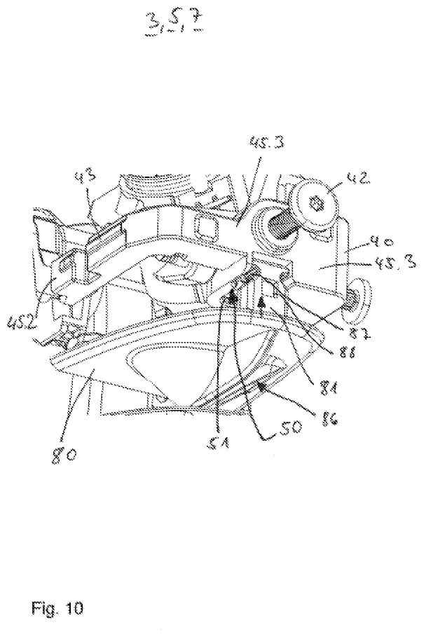

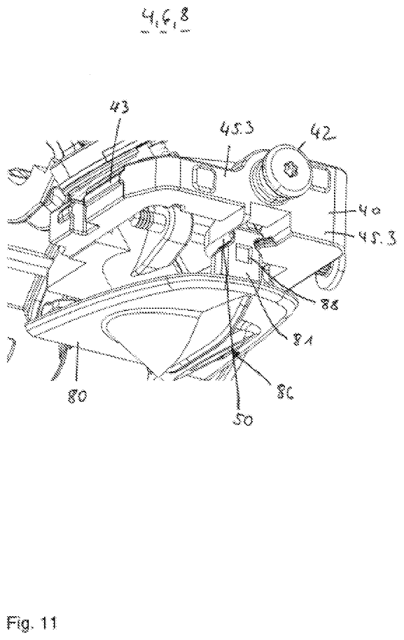

According to the exemplary embodiment according to FIG. 1 to FIG. 12, it is shown that the handle 1 has a control element 40, which is in operatively connected to a securing element 80 arranged on the outside of the door 2. The control element 40 can be moved from a retaining position 5, which is shown in FIGS. 3 to 6, FIGS. 8 and 10, to a securing position 6, which is shown in FIGS. 2, 7, 9 and 11. The control element 40 has different functions hereby, which are described below. By means of a movement of the control element 40 from the retaining position 5 to the securing position 6, the distance between the securing element 80 and the control element 40 is reduced, which is particularly illustrated in FIGS. 10 and 11. Here, the securing element 80 has a locking means 81, which engages a counter locking means 50 of the control element 40.

According to the other figures, it can be seen that the securing element 80 has, on the side opposite the locking means 81, a fastening region 82 which is arranged on the mounting carrier 30. During the movement of the control element 40 from the retaining position 5 into the securing position 6, the securing element 80 pivots about a rotation axis 83, wherein the rotation axis 83 passes through the fastening region 82. Starting with FIG. 5, a linear movement of the control element 40 to the left (see double arrow) takes place, wherein, at the same time, the securing element 80 is pivoted clockwise about the rotation axis 83, which passes through the fastening region 82. Hereby, the securing element 80 with its locking means 81 carries out a certain lifting movement in the direction of the control element 40, which is less than 2 mm. Advantageously, the securing element 80 has a seal 85 on the side 84 facing the control element 40, which is not explicitly shown.

In order for the securing element 80 to be moved in the direction of the door 2 via a movement of the control element 40 in the direction of the securing position 6, the locking means 81 of the securing element 80 has active surfaces 87 which engage counter active surfaces 51 of the control element 40 during the movement of the control element 40 into the securing position 6. The active surfaces 87 and the counter active surfaces 51 are aligned with each other in such a manner that the locking means 81 is pulled to the counter locking means 50 when the control element 40 is moved in the direction of the securing position 6. The arrow in FIG. 10, which is directed upward, shows the lifting movement of the securing element 80 which is rotatably mounted on the opposite side of the rotation axis 83.

The control element 40 has an actuator 42, wherein upon actuation of the actuator 42, the movement of the control element 40 from the retaining position 5 into the securing position 6 can be triggered and/or vice versa. Hereby, the actuator 42 is arranged on the outside of the mounting carrier 30, so that the actuator 42 can be easily operated by the operator. Hereby, the actuator 42, which is a screw member, can be operated manually. The actuator 42 acts both on the mounting carrier 30 and on the control element 40.

The mounting carrier 30 has a cavity 31, in which the control element 40 is inserted in a movable manner. The control element 40 further, on its securing sides 45.1, 45.2, has respectively a rib 43, which serves as a guide during the movement of the control element 40 on the mounting carrier 30. The securing side 45.1 is opposite the securing side 45.2. While the control element 40 is being moved, the ribs 43 slide on the wall 32 of the cavity 31.

In the retaining position 5 of the control element 40, the control element 40 engages the activation element 60, whereby the activation element 60 is obtained in a mounting position 7. A simplified mounting of the grip lever 10 on the activation element 60 is effected hereby.

The control element 40 has a retaining region 49, which engages a contact surface 61 of the activation element 60 in the retaining position 5 of the control element 40.

FIG. 5 further shows that the dome 11 of the grip lever 10 is in contact with the fastening region 82 of the securing element 80. In addition, the exemplary embodiment shows that the handle 1 can be designed with a closing cylinder unit 20. It should be noted, however, that all embodiments of the exemplary embodiment can also refer to a handle 1 that does not require a closing cylinder unit 20. In the present exemplary embodiment, the handle 1 as mentioned shows a closing cylinder unit 20 which is movably mounted on the mounting carrier 30. Here, the closing cylinder unit 20 can be brought between a pre-mounting position 3 and a final mounting position 4, wherein the closing cylinder unit 20 is mounted rotatably about an axle 21. In the retaining position 5 of the control element 40, the closing cylinder unit 20 is in its pre-mounting position 3. In the securing position 6 of the control element 40, however, the closing cylinder unit 20 is in its final mounting position 4. In the final mounting position 4, the closing cylinder unit 20 is accessible via a key from the user. If the grip lever 10 is not actuated on the door 2, the grip lever 10 completely covers the head region of the closing cylinder unit 20.

The closing cylinder unit 20 has a control geometry 22, which the control element 40 engages. Hereby, the control element 40 on a connecting element 41, which is formed like a projection and which is in operative connection with the control geometry 22. Hereby, the control geometry 22 is designed at least partially in a curved manner, whereby a rotational movement is about the axis 21 is favored.

The control element 40 has a reception 44, in which the closing cylinder unit 20 is arranged. The closing cylinder unit 20 is thus partially enclosed by the control element 40. In the present exemplary embodiment, the control element 40 has two securing sides 45.1, 45.2 and an actuation side 45.3. The actuation side 45.3 connects both opposing securing sides 45.1, 45.2. The closing cylinder unit 20 is hereby located between the securing sides 45.1, 45.2. The actuator 42 is located in the actuation side 45.3.

The control element 40 has a reception region 46 and the closing cylinder unit 20 has an axle body 23, wherein the axle 21 passes through the axle body 23. The axle body 23 is arranged in the reception region 46, wherein, during the movement of the control element 40, the axle body 23 moves within the reception region 46.

According to FIGS. 5, 6, 7, the reception region 46 has an inner region 46.1 and an edge region 46.2. The reception region 46 is designed as an opening, so that the axle body 23 can be mounted easily. In the retaining position 5 of the control element 50, the axle body 23 is located in the inner left region 46.1 of the reception region 46. In the securing position 6 of the control element 40, the axle body 23 is located at the edge region 46.2, which is shown in FIG. 7. The axle body 23 is designed like a cylinder, wherein the axle body 23 has two level surfaces 24 on its lateral surface. In the securing position 6 of the control element 40, the level surfaces 24 abut against level walls 47 of the reception region 46, whereby a locking action of the closing cylinder unit 20 on the control element 40 is effected.

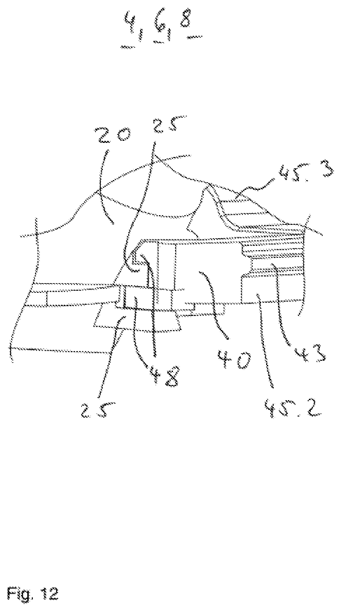

The closing cylinder unit 20 can also have a latching element 25, which, in the securing position 6 of the control element 40, engages a counter latching element 48 of the control element 40, which is shown schematically in FIG. 12. In the retaining position 5 of the control element 40, however, the latching element 25 is detached from the counter-latching element 48, which is not explicitly shown. In the following exemplary embodiment, the latching element 25 and the counter-latching element 48 is formed like a rib.

The securing element 80 has an opening 86 for access to the closing cylinder unit 20. The control element 40 is preferably made metallic for safety reasons. The securing element 80a may be made of a steel material. In a further alternative not explicitly shown, it is conceivable that the securing element 80 is designed to be closed. In this embodiment, the handle 1 is formed without the closing cylinder unit 20. Here, the control 40 may be made of a plastic.

The handle 1 according to the invention is characterized in particular by the fact that the mounting method for fastening the handle 1 to a motor vehicle is substantially simplified. First, the mounting carrier 30 is fastened to the control element 40 on the inside of the door 2. Here it is conceivable that a closing cylinder unit 20 is integrated or the mounting carrier 30 does not require a closing cylinder unit 20. Subsequently, the securing element 80 is fixed from the outside of the door 2, wherein, also from the outside, the grip lever 10 with its Dome 11 is also guided to the door 2 or fastened there. Here, the dome 11 is guided in the direction of the mounting carrier 30, wherein the activation element 60 is in the mounting position 7. In the mounting position 7, it is effected that the control element 40 holds the activation element 60 in the mounting position 7. If the dome 11 is arranged on the activation element 60, the operator can act on the actuator 42 or rotate, so that a movement of the control element 40 in the direction of securing position 4 is initiated. The activation element 60 loses contact with the control element 40, so that the activation element 60 automatically leaves the mounting position 7 in the direction of the operating position 8. Via the movement of the control element 40 in the direction of the securing position 6, a force input into the securing element 80 takes place, which is pulled about its rotation axis 83 in the direction of the control element 40. At the same time a force is exerted on the mounting carrier 30, which presses on the inside of the door 2 as a result thereof. An effective tension of the handle 1 with the door 2 can be achieved hereby.

If the handle 1 comprises a closing cylinder unit 20, the closing cylinder unit 20 can be moved from a pre-mounting position 3 into a final mounting position 4 by the movement of the control element 40 into the securing position 6. If the final mounting position 4 is reached, the latching elements 25 act with the counter-latching elements 48 of the control element 40, so that a locking position of the closing cylinder unit 20 is reached.

The above explanation of the embodiments describes the present invention exclusively in the context of examples. Of course, individual features of the embodiments, if technically feasible, can be combined freely with one another without departing from the scope of the present invention.

### LIST OF REFERENCE NUMERALS

1 Handle

2 Door

3 Pre-mounting position

4 Final mounting position

5 Retaining position

6 Securing position

7 Mounting position

8 Operating position

10 Grip lever

11 Dome

12 Free end

20 Closing cylinder unit

21 Axle

22 Control geometry

23 Axle body

24 Level surface

25 Latching elements

30 Mounting earner

31 Cavity

32 Wall

40 Control element

41 Connecting element, projection

42 Actuator

43 Ribs

44 Reception

45. 1 Securing side

45. 2 Securing side

45. 3 Actuation side

46 Reception region

46. 1 Inner region

46. 2 Edge region

47 Wall

48 Counter latching element

49 Retaining region

50 Counter locking means

51 Counter active surface

60 Actuation element

61 Contact surface

62 Fastening zone

63 Axle

64 Fastening reception

65 Mass balance

80 Securing element

81 Locking means

82 Fastening region

83 Rotation axis

84 Side

85 Seal

86 Opening

87 Active surface

88 Reception

1. A handle for a motor vehicle, with a mounting carrier, which can be fastened on the inside of a door of the motor vehicle, a grip lever (10), which can be arranged on the outside of the door of the motor vehicle and which is fastened to the mounting carrier, wherein a closing cylinder unit is movably mounted on the mounting carrier, whereby the closing cylinder unit can be brought between a pre-mounting position and a final mounting position.

2. The handle according to claim 1, wherein the closing cylinder unit is mounted rotatably about an axis.

3. The handle according to claim 1, wherein the mounting carrier has a control element that can be moved from a retaining position into a securing position, wherein, in the retaining position of the control element, the closing cylinder unit is in the pre-mounting position and in the securing position of the control element, the closing cylinder unit is in the final mounting position.

4. The handle according to claim 3, wherein the closing cylinder unit has a control geometry on which the control element acts, in particular, in that the control element has a connecting element, which is in operative connection with the control geometry.

5. The handle according to claim 4, wherein the connecting element is formed as a projection.

6. The handle according to claim 4, wherein the control geometry is at least partially curved.

7. The handle according to claim 3, wherein the control element has an actuator, wherein, upon actuation of the actuator, a movement of the control element is effected from the retaining position into the securing position and/or vice versa.

8. The handle according to claim 7, wherein the actuator is located at least partially on the outside of the mounting carrier.

9. The handle according to claim 7, wherein the actuator can be operated manually.

10. The handle according to claim 7, wherein the actuator is a screw element which acts on the mounting carrier and on the control element.

11. The handle according to claim 3, wherein the mounting carrier is designed with a cavity in which the control element is inserted, wherein the cavity is designed so that the control element is movable within the cavity between the retaining position and the securing position.

12. The handle according to claim 3, wherein the control element has a reception in which the closing cylinder unit is arranged, in particular, in that the closing cylinder unit is partially enclosed by the control element.

13. The handle according to claim 3, wherein the control element has two securing sides and one actuating side, wherein the actuating side connects both opposing securing sides and the closing cylinder unit is arranged between both securing sides.

14. The handle according to claim 3, wherein the control element has a rib on at least one of its sides, whereby a reliable guidance is effected during the movement of the control element the mounting carrier, in particular, in that at least one securing side has the rib.

15. The handle according to claim 3, wherein the control element is arranged within the mounting carrier in such a way that the control element can be moved linearly between the retaining position and the securing position.

16. The handle according to claim 3, wherein the control element has a reception region and the closing cylinder unit has an axle body through which the axis extends, wherein the axle body is arranged in the reception region, wherein in particular upon movement of the control element, the axle body moves relative within the reception region.

17. The handle according to claim 16, wherein the reception region has an inner region and an edge region, wherein the reception region is designed as an opening, which becomes smaller from the inner region to the edge region, wherein, in the retaining position of the control element, the axle body is located in the inner region and, in the securing position of the control element, the axle body is located in the edge region.

18. The handle according to claim 17, wherein the axle body is designed cylindrically, wherein a lateral surface of the axle body has at least one flat surface at least in regions, which in the securing position of the control element a wall of the reception region is contacted.

19. The handle according to claim 3, wherein the closing cylinder unit has at least one latching element which, in the securing position of the control element, engages a counter latching element of the control element, wherein, in the retaining position of the control element, the at least one latching element is detached from the counter latching element), wherein in particular the at least one latching element and/or the counter latching element is/are formed like a rib.

20. The handle according to claim 3, wherein a movable activation element is arranged on the mounting carrier, wherein, in the retaining position, the control element engages the activation element, whereby the activation element is held in a mounting position in order to enable a simplified mounting of the grip lever that in the securing position, the control element is detached from the activation element.

21. A method for mounting a handle according to claim 1 with a mounting carrier (30), which can be fastened on the inside of a door of the motor vehicle, a grip lever, which can be arranged on the outside of the door of the motor vehicle and which is fastened to the mounting carrier, a closing cylinder unit, which is arranged movably on the mounting carrier, wherein, via a movement of a control element, which is arranged on the mounting carrier and is in operative connection with the closing cylinder unit, the closing cylinder unit moves from a pre-mounting position into a final mounting position.

22. The method according to claim 21, wherein, in the pre-mounting position of the closing cylinder unit, the grip lever is arranged on the mounting carrier, in particular on an activation element movable on the mounting carrier, and subsequently the control element is moved out of a retaining position into a securing position.

23. The method according to claim 22, wherein, in the retaining position, the control element holds the activation element in a mounting position, wherein during the movement of the control element into the securing position, the control element detaches from the activation element, which moves into an operating position.
